(19) United States
(12) Patent Application Publication
(10) Pub. No.: US 2008/0136980 A1
(43) Pub. Date: Jun. 12, 2008

(54) Liquid crystal display device and method of fabricating the same

(75) Inventors: Soo-Guy Rho, Suwon-si (KR); Myung-Woo Lee, Seoul (KR); Young-Nam Yun, Gunpo-si (KR); Ji-Hye Moon, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/999,899

(22) Filed: Dec. 7, 2007

(30) Foreign Application Priority Data
Dec. 8, 2006 (KR) 10-2006-0124513

(51) Int. Cl. G02F 1/1335; H01J 9/00

(52) U.S. Cl. 349/12; 445/24

(57) ABSTRACT

A touch sensor equipped liquid crystal display device includes a first substrate having an image display device, a second substrate having a plurality of column spacers, a liquid crystal layer disposed between the first and second substrates. A touch sensor is driven by pressing on the second substrate. A gap maintaining region combines with the column spacers to maintain a gap between the first and second substrates, and a sensing region formed lower than the gap maintaining region achieves a sensing of the touch sensor responsive to the pressing on the second substrate.

### RELATED APPLICATIONS

This application claims priority from Korean Patent Application No. 10-2006-0124513, filed Dec. 8, 2006, the entire disclosure of which is incorporated herein by reference.

### BACKGROUND

This disclosure relates to a touch sensor equipped liquid crystal display device and method of fabricating the same.

Generally, a touch sensor equipped liquid crystal display device has a touch sensor arranged between a thin film transistor substrate and a color filter substrate.

A liquid crystal display (“LCD”) device includes a thin film transistor substrate with a thin film transistor (“TFT”) switching device and a color filter substrate having a color filter formed thereon. A liquid crystal layer is arranged between the TFT substrate and the color filter substrate.

In a touch sensor equipped LCD device, as shown in FIG. 1, a plurality of supporting column spacers 130 are spaced apart from each other between a color filter substrate 120 and a TFT substrate 110. The column spacers 130 maintain a uniform gap between the substrates 120 and 110. A sensing column spacer 140 between the two substrates 120 and 110 senses coordinates the color filter substrate 120 is pressed. A sensor electrode 160 is arranged under the sensing column spacer 140.

A predetermined gap, or sensor gap d′, is arranged between the sensor electrode 160 and the sensing column spacer 140. Accordingly, the sensing column spacer 140 is shorter than the supporting column spacer 130 by a distance equal corresponding to the size of the sensor gap ‘d’. The sensing column spacer 140, which is normally spaced apart from the sensor electrode 160, comes into contact with the sensor electrode 160 when the color filter substrate 120 is pressed, thereby transmitting a signal voltage to the sensor electrode 160 corresponding to a coordinate value of the pressed position. The coordinate value of the pressed position may be recognized by sensing the signal voltage from the sensor electrode 160.

However, since the supporting column spacer 130 and the sensing column spacer 140 have different heights, the process for forming the column spacer is complicated.

Moreover, since the sensor gap is determined by the length of the column spacer, it may be difficult to manage the sensitivity of the touch sensor.

### BRIEF SUMMARY

In accordance with the exemplary embodiments disclosed herein a liquid crystal display device includes a first substrate having an image display device, a second substrate having a plurality of column spacers, a liquid crystal layer disposed between the first and second substrates, a touch sensor driven by pressing on the second substrate, a gap maintaining region combined with the column spacers to maintain a gap between the first and second substrates, and a sensing region formed lower than the gap maintaining region to achieve a sensing of the touch sensor responsive to the pressing on the second substrate.

The plurality of the column spacers may be substantially equal to each other in height.

The column spacers may include a first column spacer contacting the gap maintaining region, and a second column spacer provided to the sensing region, wherein an area of the first column spacer may be greater than an area of the second column spacer.

The gap maintaining region may include an insulating layer and a gap maintaining layer. In this case, the gap maintaining layer may include at least one of a gate metal, a data metal and a semiconductor layer.

The gap maintaining region may further include an elastic layer. The elastic layer may be formed of an organic material.

The sensing region may include an insulating layer. Further, the sensing region may have a sensing recess.

The image display device may include a thin film transistor having a gate electrode, a semiconductor layer, a source electrode, and a drain electrode, a pixel electrode connected to the thin film transistor, and a common electrode receiving a common voltage and generating an electric field together with the pixel electrode.

The touch sensor may include a first conductive line, a second conductive line crossing the first conductive line, a first conductive pad connected to the first conductive line, a second conductive pad connected to the second conductive line and spaced apart from the first conductive pad, and a connecting electrode formed on a surface of the column spacer to electrically connect the first and second conductive pads by pressing on the second substrate.

The first and second conductive pads may be formed at substantially the same height. The connecting electrode is spaced apart from each of the first and second conductive pads by about 4,000 to about 5,000 Å.

In accordance with exemplary embodiments disclosed herein, a method of fabricating a liquid crystal display device includes forming a gap maintaining region and a sensing region lower than the gap maintaining region on a first substrate, forming a first conductive pad connected to a first conductive line and a second conductive pad connected to a second conductive line in the sensing region, forming a second substrate having at least one column spacer provided to positions corresponding to the gap maintaining region and sensing region, forming a connecting electrode on a surface of the column spacer, and injecting liquid crystals between the first and second substrates to bond together.

The forming the gap maintaining region and sensing region may include forming an image display device having a thin film transistor and a pixel electrode on the first substrate, forming the first and second conductive lines and the first and second conductive pads on the first substrate, patterning a metal layer or a semiconductor layer to form the gap maintaining region, and forming the sensing region using an insulating layer.

The forming the gap maintaining region may further include forming an elastic layer projected upward.

The forming sensing region may further include forming a sensing recess by etching the insulating layer.

In forming the second substrate, the at least one column spacer may be formed with substantially the same height.

It is to be understood that both the foregoing general description and the following detailed description of the present disclosure are exemplary and explanatory and are intended to provide further explanation of the invention as claimed. A better understanding of the above and many other features and advantages of this invention may be obtained from a consideration of the detailed description thereof below, particularly if such consideration is made in conjunction with the several views of the appended drawings, wherein, wherever possible, like elements are referred to by like reference numerals throughout.

### BRIEF DESCRIPTION OF THE DRAWINGS

FIG. 1 is a cross-sectional diagram of an exemplary embodiment of a touch sensor equipped LCD device;

FIG. 2 is a layout of an exemplary embodiment of an LCD device;

FIG. 3 is a cross-sectional diagram taken along line I-I′ shown in FIG. 1;

FIG. 4 is a cross-sectional diagram taken along line II-II′ shown in FIG. 1;

FIG. 5 is a cross-sectional diagram taken along line III-III′ shown in FIG. 1;

FIG. 6 is a cross-sectional diagram of an exemplary embodiment of a sensing region;

FIGS. 7A, 7B, and 7C are cross-sectional diagrams illustrating exemplary embodiments of a process for forming a first conductive pattern in a method of fabricating an LCD device;

FIGS. 8A, 8B, and 8C are cross-sectional diagrams illustrating exemplary embodiments of a process for forming a semiconductor layer in a method of fabricating an LCD device;

FIGS. 9A, 9B, and 9C are cross-sectional diagrams illustrating exemplary embodiments of a process for forming a second conductive pattern in a method of fabricating an LCD device;

FIGS. 10A, 10B, and 10C are cross-sectional diagrams illustrating exemplary embodiments of a process for forming a passivation layer in a method of fabricating an LCD device;

FIGS. 11A, 11B, and 11C are cross-sectional diagrams illustrating exemplary embodiments of a process for forming a third conductive pattern in a method of fabricating an LCD device;

FIG. 12 is a cross-sectional diagram illustrating exemplary embodiments of a process for forming an elastic layer according to an exemplary embodiment of the present invention; and

FIGS. 13, 14, and 15 are cross-sectional diagrams illustrating exemplary embodiments of a process for fabricating a second substrate.

### DETAILED DESCRIPTION

FIGS. 2 to 6 illustrate an exemplary embodiment of an LCD device.

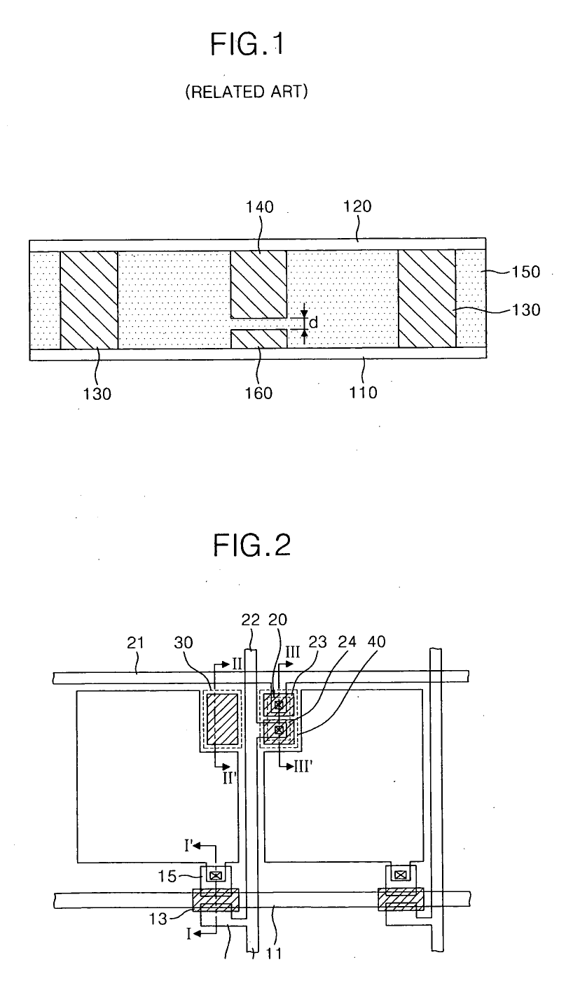

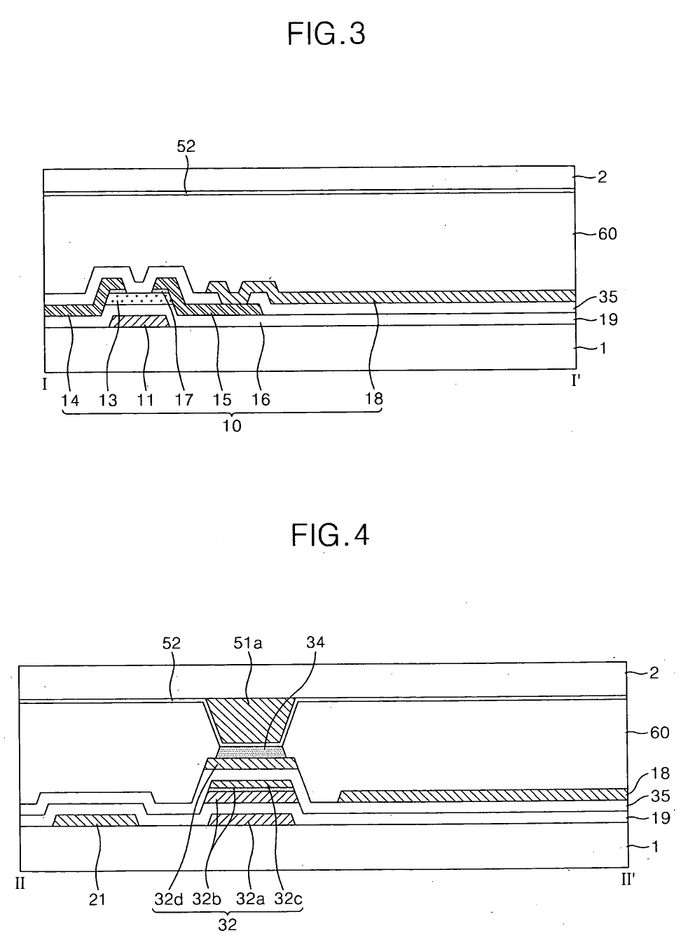

FIG. 2 is a layout of an exemplary embodiment of an LCD device, FIGS. 3, 4, and 5 are cross-sectional diagrams taken along lines I-I′, II-II′, and III-III′, respectively, shown in FIG. 1, and FIG. 6 is a cross-sectional diagram of an alternative exemplary embodiment of a sensing region.

Referring to FIGS. 2 to 5, an exemplary embodiment of an LCD device may include a first substrate 1, a second substrate 2, a liquid crystal layer 60, a touch sensor 20, an image display device 10, a gap maintaining region 30, and a sensing region 40.

The first substrate 1 is provided with a gate line 11, a data line 12, and the image display device 10. The first substrate 1 may include a transparent insulating substrate such as a glass substrate or a plastic substrate.

For example, a plurality of gate lines 11 are arranged parallel to be spaced apart from each other. A scan signal for driving a TFT is applied to the corresponding gate line 11. The gate line 11 may be formed of a metal based single layer or a metal based multi-layer. In case of the multi-layer, the gate line 11 may be formed of a transparent conductive layer and a non-transparent metal layer stacked on the transparent conductive layer.

The data line 12 is insulated from the gate line 11 and arranged to be substantially perpendicular to the gate line 11. Like the gate lines 11, a plurality of data lines 12 are arranged parallel with each other. In the present embodiment, one touch sensor may be allocated per three sub-pixels. Therefore, a space between the first data line of one group of three sub-pixels and the third data line of a neighboring group of three data lines is wider than a space between the data lines within each group of three data lines in order to provide an arrangement with space to accommodate the corresponding touch sensor. The density of the touch sensors for a given arrangement, the arrangement density, may be modified in various ways within the LCD device depending on how the touch sensors are arranged. As the touch sensors are arranged more densely, a coordinate value can be more precisely sensed. As the touch sensors are arranged less densely, a coordinate value can be less precisely sensed.

Like the gate line 11, the data line 12 may be formed of a metal based single layer or a metal based multi-layer. A pixel signal is applied to the data line 12 and transmitted to a pixel electrode via a TFT.

The TFT includes a gate electrode, a semiconductor layer 13, a source electrode 14, and a drain electrode 15. The gate electrode is connected to the gate line 11. A scan signal is transmitted through the gate line 11 to control a turn-on time of the TFT. The semiconductor layer 13 overlays the gate electrode with a gate insulating layer 16 disposed therebetween. The semiconductor layer 13 may be formed of amorphous silicon or polysilicon. Alternatively, an ohmic contact layer 17 may be further formed on the semiconductor layer 13. The ohmic contact layer 17 is provided to form ohmic contact between the semiconductor layer 13 and the source or drain electrode 14 or 15.

One end of the source electrode 14 is connected to the data line 12 and the other end of the source electrode 14 partially overlaps the semiconductor layer 13. So, a pixel signal is applied to the source electrode 14 from the data line 12 and then transmitted to the drain electrode 15 via a channel formed in the semiconductor layer 13. One end of the drain electrode 15 partially overlaps the semiconductor layer 13 and the other end of the drain electrode 15 is connected to the pixel electrode 18.

The pixel electrode 18, as shown in FIGS. 2 and 3, is connected to the drain electrode 15 and is arranged in the pixel area. The pixel electrode 18 may have one of various patterns to enhance a viewing angle or lateral visibility.

The second substrate 2 is provided with a color filter (not shown), a common electrode 52, and first and second column spacers 51a and 51b. Alternatively, the color filter may be formed on the first substrate 1. The color filter is provided to display a color for each pixel area. The color filter includes three kinds of colors, red (R), green (G), and blue (B). A single-color color filter is provided to each sub-pixel. A pixel may consist of three sub-pixels representing, for example, red, green and blue.

The common electrode 52 forms an electric field for driving liquid crystals together with the pixel electrode 18. A common voltage as a reference voltage is applied to the common electrode 52 to generate the electric field.

The common electrode 52 may extend widely on a surface of the second substrate 2 and may be patterned in order to increase the viewing angle. Since the common electrode 52 is formed on the second substrate 2 in the present embodiment, the electric field generated by the pixel electrode 18 and the common electrode 52 is a vertical electric field or a fringe type electric field.

Alternatively, the common electrode may be formed on the first substrate 1. In an example embodiment, a horizontal electric field or a fringe type electric field is generated by the pixel electrode 18 and the common electrode 52 provided to the first substrate 1.

The first and second column spacers 51a and 51b are projected from the second substrate 2 and are coated with the common electrode 52. The first column spacer 51a is arranged in the gap maintaining region 30 (see FIG. 2) and the second column spacer 51b is arranged in the sensing region 40 (see FIG. 2). The first column spacer 51a, as shown in FIG. 4, is in contact with the first substrate 1 in the gap maintaining region 30 and functions as a supporting column spacer maintaining a gap between the first and second substrates 1 and 2. The first column spacer 51a may have elasticity to improve sensitivity so that the first column spacer 51a is slightly compressed when the second substrate 2 is pressed and expands to its original state when the force on the second substrate 2 is released.

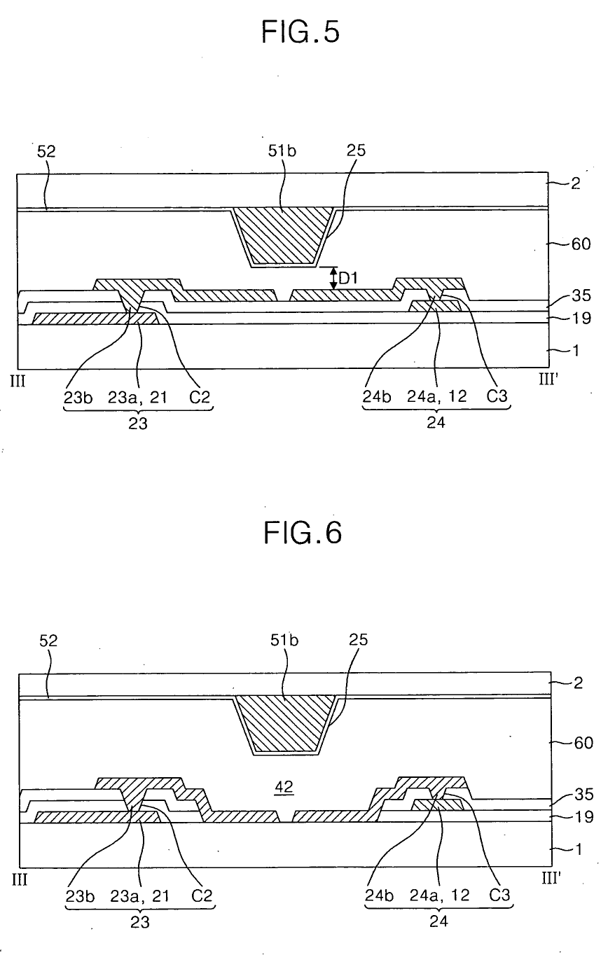

The second column spacer 51b, as shown in FIG. 5, is provided to be spaced apart from the first substrate 1 with a predetermined gap D1 and functions as a sensing column spacer which contacts a conductive pad when a force is applied to the second substrate 2. In the present embodiment, all the column spacers 51a and 52b have substantially the same height.

The column spacers 51a and 51b may be formed of conductive polymer such as poly(3,4-ethylenedioxythiophene) (PEDOT), PProDOT-(CH₃)₂, or polystyrenesulfonate (PSS) or an organic insulating material such as acrylic resin.

The area of the first column spacer 51a is greater than that of the second column spacer 51b. The area of the column spacer means a surface area of an upper or lower surface of the column spacer and may correspond to one of the horizontal cross-sections of the column spacer. The first column spacer 51a uniformly maintains the gap between the first and second substrates 1 and 2. On the other hand, the second column spacer 51b does not maintain the gap between the first and second substrates 1 and 2. Accordingly, the first column spacer 51a has sufficient rigidity to maintain the gap between the first and second substrates 1 and 2. The second column spacer 51b, on the other hand, does not have to have the same rigidity as the first column spacer 51a.

Since both of the first and second column spacers 51a and 51b do not display an image, it is advantageous to configure them with small sizes so as to maximize the image producing surface of the display. Even if the area of the first column spacer 51a is increased in order to maintain the gap, the second column spacer 51b may have a minimum area.

The gap maintaining region 30 is formed on the first substrate 1 to maintain the gap between the first and second substrates 1 and 2. The LCD device according to the present embodiment is a touch sensor equipped LCD device. Accordingly, the gap between the first and second substrates 1 and 2 should be uniform so as to provide good sensitivity for the touch sensor.

In the present embodiment, the gap maintaining region 30 of the substrate 1 is configured at a portion of the substrate 1 that is higher, relative to the surface of the substrate 1, than the sensing region 40. Both the supporting column spacer and the sensing column spacer are formed as column spacers with substantially the same height, relative to the surface of the second substrate 2, as shown in FIG. 15. The column spacer is therefor spaced apart from the conductive pad in the sensing region 40 to provide the sensor gap.

In the present embodiment, the gap maintaining region 30 includes insulating layers 19 and 35 and a gap maintaining layer 32 as shown in FIG. 4. In contrast, the sensing region 40 on substrate 1 may include insulating layers 19 and 35 and upper conductive pads 23b, 24b as shown in FIG. 5 or the upper conductive pads 23b, 24b in a sensing recess 42 as shown in FIG. 6. The gap maintaining region 30 on the substrate 1, on the other hand, may include the gap maintaining layer 32 and may be configured higher than the sensing region 40 relative to the surface of the substrate 1.

The gap maintaining layer 32 may be configured in various ways by considering the sensor gap. In the present embodiment, the gap maintaining layer 32 includes first to fourth gap maintaining layers 32a, 32b, 32c and 32d. The first to the fourth gap maintaining layers 32a, 32b, 321c and 32d may be formed of the layers configuring the TFT on the first substrate 1. Accordingly, an additional process for configuring the gap maintaining layer is unnecessary.

In contrast to embodiments in which the sensor gap depends on the height difference between the supporting column spacer and the sensing column spacer, the thickness of the gap maintaining layer 32 may determine the sensor gap in an exemplary embodiment in accordance with this disclosure. Therefore, a uniform sensor gap across the entire surface of the substrate may be obtained. This is because to adjust the thickness of a layer by deposition is easier and more precise than to adjust the thickness of a layer by an etch of a deposited layer.

An arrangement density of the gap maintaining region 30 may be varied in various ways by considering several factors including elasticity of the column spacer, elasticity of the second substrate, etc.

Since the gap maintaining region 30 is unable to display an image, an aperture ratio may be increased by minimizing the area of the surface area of the gap maintaining region 30.

In order to increase the sensitivity of the sensor, an elastic layer 34, as shown in FIG. 4, may be further provided to the gap maintaining region 30. The elastic layer 34 may be formed of an organic material having good elasticity. The elastic layer 34 is overlapped with the first column spacer 51a. The elastic layer 34 compresses to enable the second column spacer 51b to easily contact the conductive pad when a force is applied on the second substrate 2, for example by pressing. The elastic layer 34 may be formed by patterning an organic passivation layer formed on the first substrate 1 to protect the TFT.

In an example embodiment, the sensing region 40 is an area where the sensing of the touch sensor is carried out. The sensing region 40 may be lower than the gap maintaining region 30 to obtain an appropriate sensor gap. In contrast to the gap maintaining region 30, the sensing region 40 includes only the insulating layers 19 and 35 without the gap maintaining layer 32. So, the sensing region 40 is lower than the gap maintaining region 30 by the thickness of the gap maintaining layer 32. In an example embodiment, the insulating layer may include at least one of various insulating layers, which are used in forming the TFT, such as a gate insulating layer, an inorganic passivation layer, an organic insulating layer, etc.

Alternatively, a sensing recess 42, as shown in FIG. 6, may be provided to the sensing region 40 to have a predetermined depth. As described above, an exemplary embodiment may maintain the sensor gap using the thickness of the gap maintaining layer 32. In embodiments where the gap maintaining layer 32 is not enough to secure a sufficient sensor gap, the sensing recess 42 may be formed by partially etching the insulating layers 19 and 35 on the sensing region 40. This is advantageous where using the depth of the sensing recess 42 as the sensor gap is necessary to provide a desired sensor gap. However, if the thickness of the gap maintaining layer 32 is enough to provided a desired sensor gap, the sensing recess 42 is unnecessary.

The touch sensor 20 includes a first conductive line 21, a second conductive line 22, a first conductive pad 23, a second conductive pad 24, and a connecting electrode 25.

The first conductive line 21, as shown in FIG. 2, is parallel with the gate line 11 and determines a coordinate value in a vertical direction on the drawing. The first conductive line 21 is formed of the same metal as the gate line and a common line on the same layer.

The first conductive pad 23 is connected to the first conductive line 21 and contacts the connecting electrode 25 by pressing on the second substrate 2. In the present embodiment, the first conductive pad 23 includes a first lower conductive pad 23a and a first upper conductive pad 23b. The first lower conductive pad 23a, as shown in FIG. 5, may be provided to the same layer of the first conductive line 21. The first upper conductive pad 23b is connected to the first lower conductive pad 23a via a contact hole C2 and provided over the first lower conductive pad 23a.

The second conductive line 22, as shown in FIG. 2, is provided parallel with the data line 12. The second conductive line 22 determines a coordinate value in a horizontal direction on the drawing. The second conductive pad 24 is connected to the second conductive line 22. Similar to the first conductive pad 23, the second conductive pad 24 includes a second lower conductive pad 24a and a second upper conductive pad 24b.

The second lower conductive pad 24a, as shown in FIG. 5, is formed of the same metal and layer as the data line 12. The second upper conductive pad 24b is connected to the second lower conductive pad 24a via a contact hole C3. The second upper conductive pad 24b, as shown in FIG. 5, is provided at substantially the same height as the first upper conductive pad 23b. Thus, the first and second upper conductive pads 23b and 24b have substantially the same height on the first substrate 1 and facilitate the simultaneous connection by the connecting electrode 25.

The connecting electrode 25 contacts the first and second conductive pads 23 and 24 to transfer a signal voltage when the second substrate 2 is pressed. The connecting electrode 25, as shown in FIG. 5, is deposited on a surface of the second column spacer 51b.

In the present embodiment, the common electrode 52 on the second substrate 2 may be used as the connecting electrode 25. Instead of forming an additional connecting electrode, a portion of the common electrode 52 is usable as the connecting electrode 25. The common voltage is applied to the connecting electrode 25 to become a signal voltage for driving the touch sensor.

The connecting electrode 25, as shown in FIG. 5, is spaced apart from each of the first and second conductive pads 23b and 24b to leave a predetermined gap. In the present embodiment, the predetermined gap becomes the sensor gap. The sensor gap may be about 4,000 to about 5,000 Å for good sensor sensitivity.

Finally, the liquid crystal layer 60 is provided between the first substrate 1 and the second substrate 2. The liquid crystal layer 60 is driven by an electric field between the pixel and common electrodes 18 and 52. And, transmittance of light through the liquid crystal layer 60 is controlled to display an image.

The present embodiment may be applied to both vertical and horizontal electric field type liquid crystal display devices.

Although the gap maintaining region 30 and the sensing region 40 are additionally provided to the first substrate 1, a hither portion or the substrate, for example a portion which is higher than another portion of the substrate by the thickness of a TFT or various lines on the first substrate, may be used as the gap maintaining region and the lower portion of the substrate may be used as the sensing region. In an example embodiment, the process of fabricating the LCD device may be simplified by using the previously formed portions as the gap maintaining and sensing regions. In addition, it may also be possible to avoid reducing an aperture ratio by the additional gap maintaining or sensing region formation that may otherwise be present.

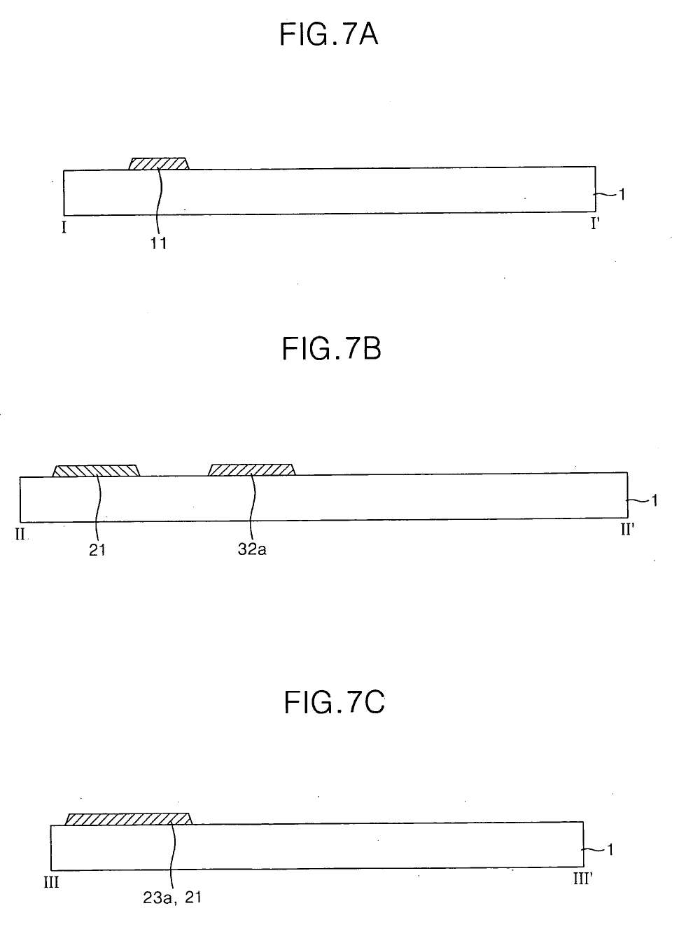

FIGS. 7A to 15 illustrate an exemplary embodiment of fabricating the LCD device as follows.

FIGS. 7A, 8A, 9A, 10A, and 11A are cross-sectional views of an exemplary embodiment of the pixel region taken along line I-I′ of FIG. 2.

FIGS. 7B, 8B, 9B, 10B, and 11B are cross-sectional views of an exemplary embodiment of the gap maintaining region taken along line II-II′ of FIG. 2.

FIGS. 7C, 8C, 9C, 10C, and 11C are cross-sectional views of an exemplary embodiment of the sensing region taken along line III-III′ of FIG. 2.

Referring to FIGS. 7A to 7C, a first conductive pattern is formed. The first conductive pattern includes the gate line 11, the gate electrode, the first gap maintaining layer 32a, the first conductive line 21, and the first lower conductive pad 23a.

More specifically, a first conductive layer is deposited on an upper surface of a first substrate 1. In an example embodiment, the first conductive layer may be formed of a metal based single layer or a metal based multi-layer. The first conductive layer is patterned to form the gate line 11 and the gate electrode in the pixel area as shown in FIG. 7A, the first gap maintaining layer 32a in the gap maintaining region 30 as shown in FIG. 7B, and the first conductive line 21 and the first lower conductive pad 23a in the sensing region as shown in FIG. 7C.

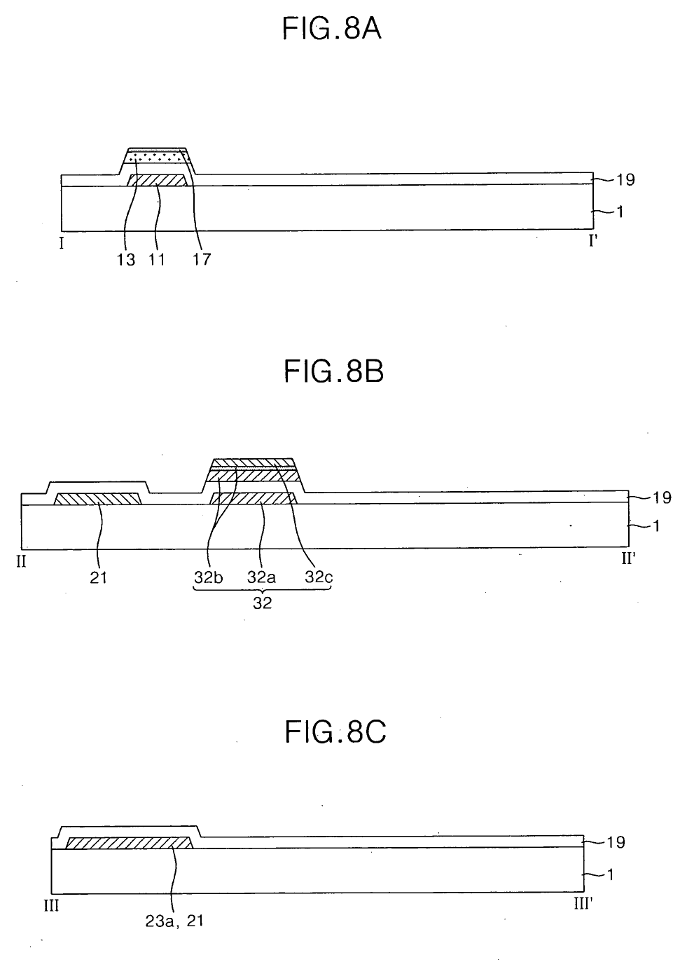

Referring to FIGS. 8A to 8C, the semiconductor layer 13 and the ohmic contact layer 17 are formed in the pixel area, and the second gap maintaining layer 32b is formed in the gap maintaining region.

Specifically, three layers including a gate insulating layer, a semiconductor layer, and a doped semiconductor layer are sequentially deposited on the first substrate 1 on which the first conductive pattern is formed. The three layers are patterned to form the semiconductor layer 13 and the ohmic contact layer 17 in the pixel area as shown in FIG. 8A and the second gap maintaining layer 32b in the gap maintaining region 30 as shown in FIG. 8B. The second gap maintaining layer 32b consists of the semiconductor layer and the ohmic contact layer. Optionally, the second gap maintaining layer 32b may be omitted. In the sensing region, only the gate insulating layer 19 is left, and the semiconductor layer and the ohmic contact layer are removed by an etching process as shown in FIG. 8C.

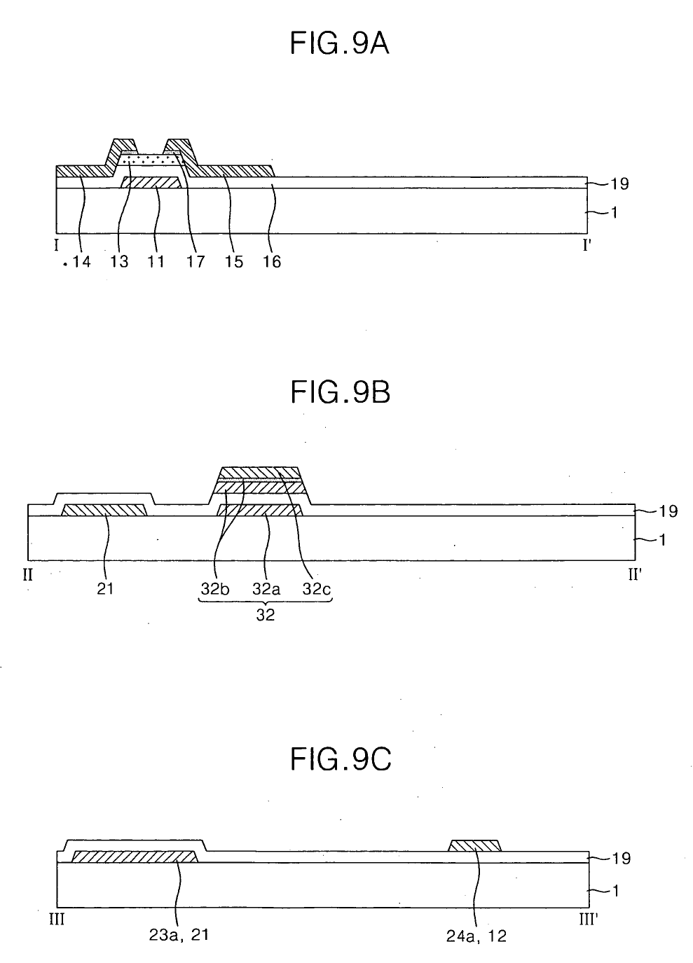

Referring to FIGS. 9A to 9C, a second conductive pattern is formed on the first substrate 1. The second conductive pattern includes the data line 12 (refer to FIG. 2), the source electrode 14, the drain electrode 15, the third gap maintaining layer 32c, the second conductive line 22, and the second lower conductive pad 24a.

Specifically, a second conductive layer is deposited on the first substrate 1. In an example embodiment, the second conductive layer may include a metal based single layer or a metal based multi-layer. The second conductive layer is patterned to form the data line 12, the source electrode 14, and the drain electrode 15 in the pixel area as shown in FIG. 9A and the third gap maintaining layer 32c in the gap maintaining region 30 as shown in FIG. 9B. Alternatively, the third gap maintaining layer 32c may be omitted. And, the second conductive line 22 and the second lower conductive pad 24a are formed in the sensing region 40 as shown in FIG. 9C.

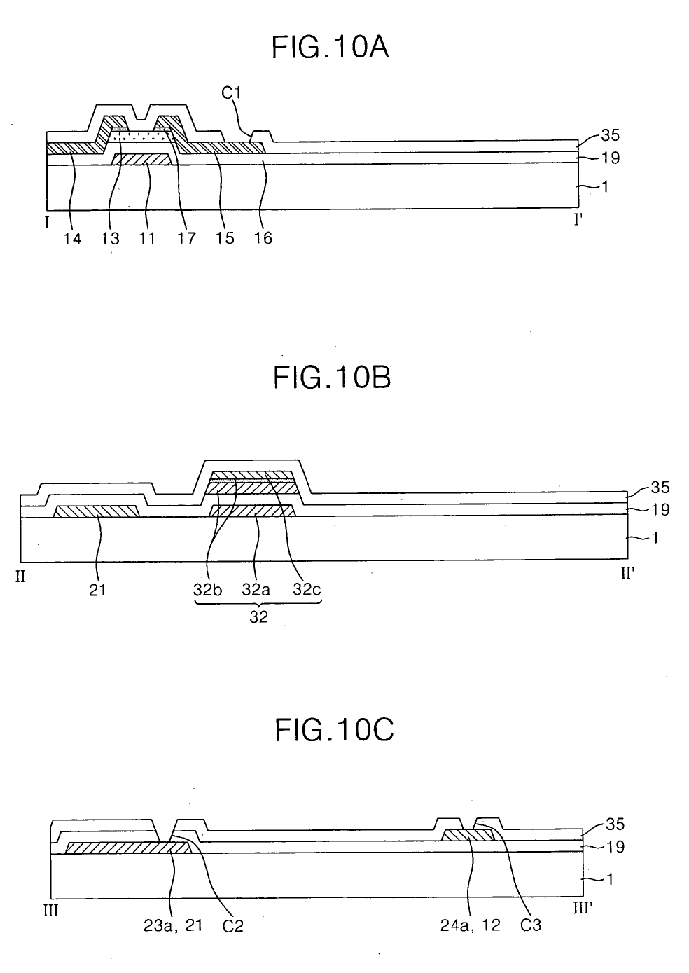

Referring to FIGS. 10A to 10C, a passivation layer is deposited over the first substrate 1 and is then patterned to form contact holes C1, C2 and C3. The passivation layer 35 may be formed of an inorganic or organic passivation layer. Alternatively, the passivation layer 35 may be configured with a double layer including an inorganic passivation layer and an organic passivation layer on the inorganic passivation layer.

For example, the passivation layer 35 is patterned to form the first contact hole C1 exposing a portion of the drain electrode 15 as shown in FIG. 10A and the second contact hole C2 exposing the first lower conductive pad 23a and the third contact hole C3 exposing the second lower conductive pad 24a in the sensing region as shown in FIG. 10C. The passivation layer 35 in the gap maintaining region 30 is not patterned to maintain the passivation layer 35 on the third gap maintaining layer 32c as shown in FIG. 10B. The second contact hole C2 may be formed by removing the passivation layer 35 and the gate insulating layer 19, whereas the third contact hole C3 may be formed by removing only the passivation layer 35.

Alternatively, the sensing recess 42 may be further formed in the sensing region 40 as shown in FIG. 6. The sensing recess 42 may be formed by etching the passivation layer or the gate insulating layer where the first and second lower conductive pads are not formed. In embodiments in which a sufficient sensor gap is not formed by the gap maintaining layer, the sensing recess provides a sufficient sensing gap. Accordingly, this step may be unnecessary if the gap maintaining layer provides the sufficient sensor gap.

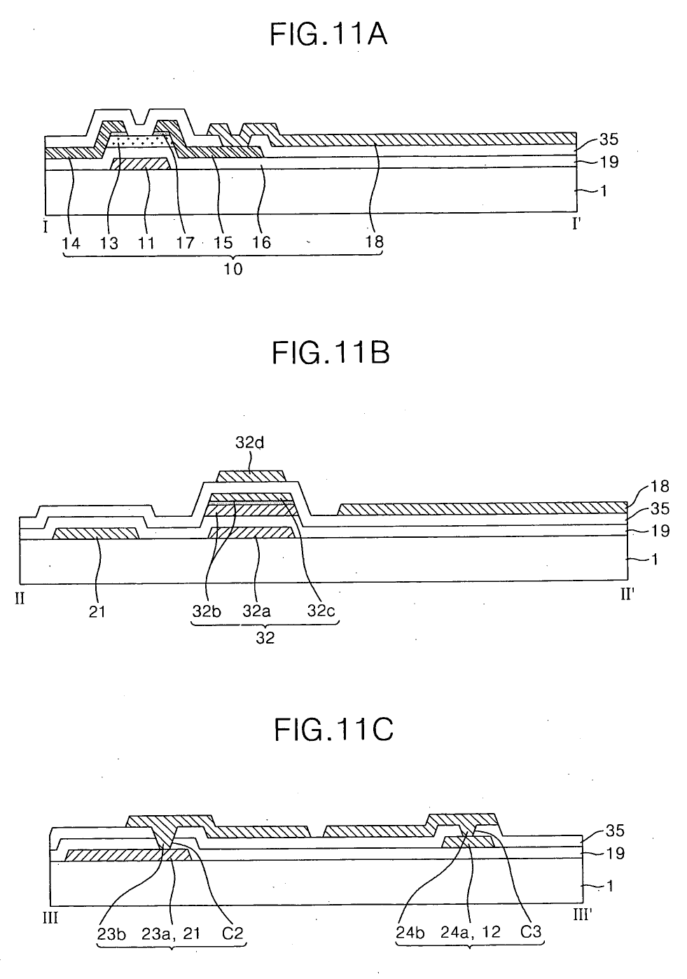

Referring to FIGS. 11A to 11C, a third conductive pattern is formed on the passivation layer 35. The third conductive pattern includes the pixel electrode 18, the fourth gap maintaining layer 32d, the first upper conductive pad 23b, and the second upper conductive pad 24b.

For example, a third conductive layer is deposited over the first substrate 1. The third conductive layer is provided for a pixel electrode. So, the third conductive layer is formed of a transparent conductive material such as indium tin oxide (ITO), indium zinc oxide (IZO), or indium tin zinc oxide (ITZO).

The third conductive layer may be patterned to form the pixel electrode 18 in the pixel area as shown in FIG. 11A and the fourth gap maintaining layer 32d in the gap maintaining are 30 as shown in FIG. 11B. Alternatively, the fourth gap maintaining layer 32d may be omitted. And, the first upper conductive pad 23b and the second upper conductive pad 24b are formed in the sensing region 40 as shown in FIG. 11C.

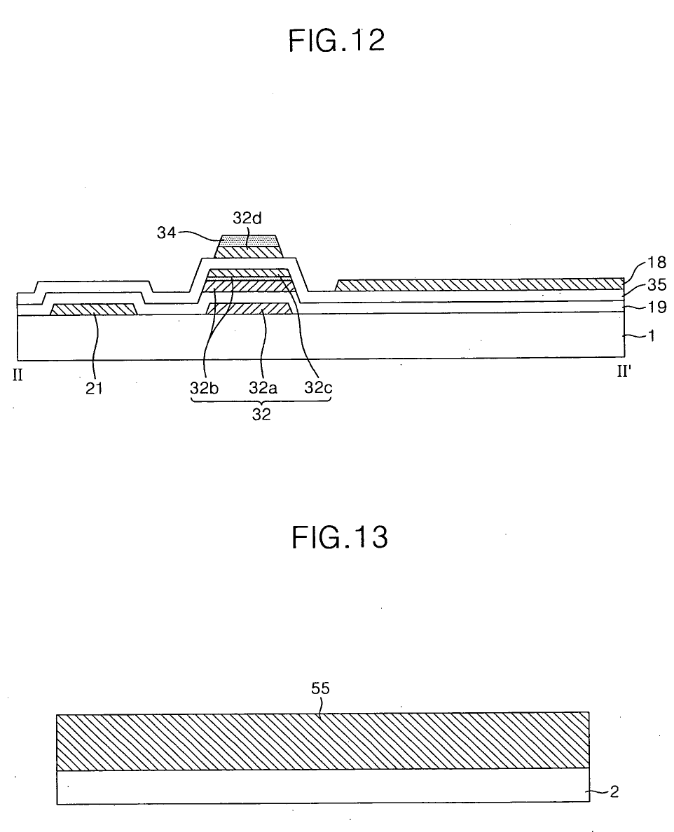

In the gap maintaining region 30, the elastic layer 34 may be further formed as shown in FIG. 12.

FIG. 12 is a cross-sectional diagram illustrating an exemplary embodiment of a process for forming the elastic layer 34 according to an exemplary embodiment of the present invention.

Referring to FIG. 12, an organic layer is coated over the first substrate 1 and is then patterned to form the elastic layer 34 on the fourth gap maintaining layer 32d. The organic layer is formed of a material having good elasticity.

FIGS. 13 to 15 are cross-sectional diagrams illustrating an exemplary embodiment of a process for fabricating a second substrate according to an exemplary embodiment of the present invention.

Referring to FIG. 13, an organic layer 55 is deposited on a second substrate 2 to a predetermined thickness. In an example embodiment, the predetermined thickness is decided by considering a gap between the first and second substrates 1 and 2. For example, the organic layer 55 may be formed to have a substantially uniform thickness on a whole surface of the second substrate 2.

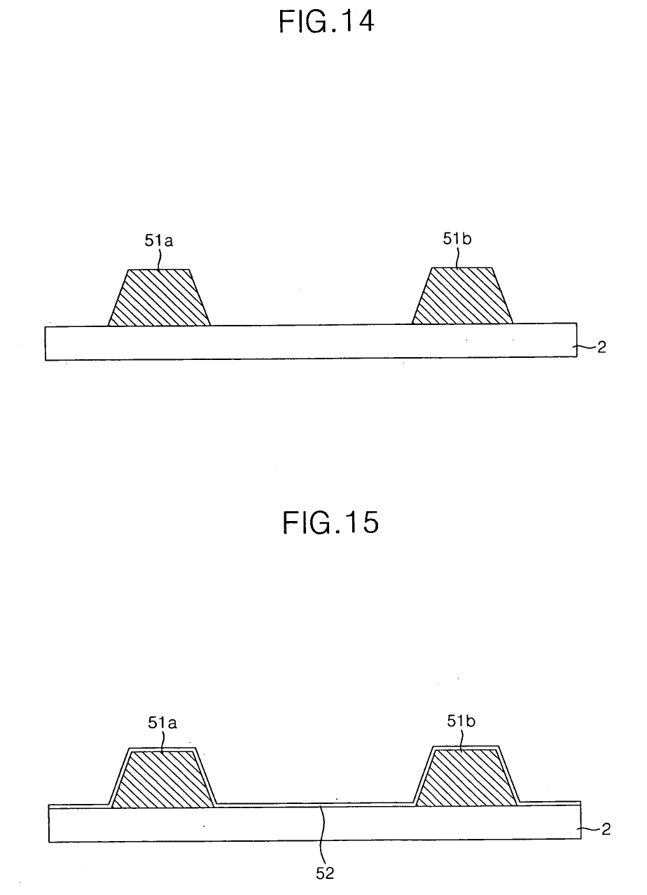

Referring to FIG. 14, the organic layer 55 is patterned to form the first and second column spacers 51a and 51b. For example, the organic layer may be exposed and developed using a mask to leave only the column spacer 51 by removing the rest of the organic layer. In an example embodiment, a position of the column spacer may be variously modified according to required sensor sensitivity.

Moreover, the first and second column spacers 51a and 51b may be configured to differ from each other in area. For example, the first column spacer 51a may be configured to have an area greater than that of the second column spacer 51b. Since the first and second column spacers 51a and 51b are formed by developing the organic layer of the same thickness, a height of the first column spacer 51a is substantially equal to that of the second column spacer 51b. Thus, the present embodiment is advantageous in forming both of the first and second column spacers 51a and 51b by a single process, thereby simplifying the process.

Referring to FIG. 15, the common electrode 52 is formed. For example, a transparent conductive layer is formed over a whole surface of the second substrate 2 provided with the column spacers 51a and 51b. The transparent conductive layer is formed over the whole surface of the second substrate 2 to be used as the common electrode 52. And, a transparent electrode formed on a surface of the second column spacer 51b functions as the connecting electrode 25.

Subsequently, the first and second substrates 1 and 2 are bonded together and a liquid crystal layer is injected therebetween. Specifically, the first and second substrates 1 and 2 are precisely aligned with each other in a manner that the first column spacer 51a corresponds to the gap maintaining region 30 and the second column spacer 51b corresponds to the sensing region 40.

As is apparent from the foregoing description, since a sensor gap may be formed using a metal layer or a semiconductor layer deposited to configure a TFT on a first substrate, the sensitivity of the touch sensor can be enhanced.

Further, since a supporting column spacer and a sensing column spacer are configured to have substantially the same height, the spacers are formed by a single process.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A liquid crystal display device, comprising:
a first substrate having an image display device;
a second substrate having a plurality of column spacers;
a liquid crystal layer disposed between the first and second substrates;
a touch sensor driven by pressing on the second substrate;
a gap maintaining region combined with the column spacers to maintain a gap between the first and second substrates; and
a sensing region formed lower than the gap maintaining region to achieve a sensing of the touch sensor responsive to the pressing on the second substrate.

2. The liquid crystal display device of claim 1, wherein the plurality of column spacers are substantially equal to each other in height.

3. The liquid crystal display device of claim 2, wherein the column spacers comprise:
a first column spacer contacting the gap maintaining region; and
a second column spacer disposed in the sensing region,
wherein an area of the first column spacer is greater than an area of the second column spacer.

4. The liquid crystal display device of claim 2, wherein the gap maintaining region comprises an insulating layer and a gap maintaining layer.

5. The liquid crystal display device of claim 4, wherein the gap maintaining layer comprises at least one of a gate metal, a data metal and a semiconductor layer.

6. The liquid crystal display device of claim 5, wherein the gap maintaining region further comprises an elastic layer.

7. The liquid crystal display device of claim 6, wherein the elastic layer is formed of an organic material.

8. The liquid crystal display device of claim 2, wherein the sensing region comprises an insulating layer.

9. The liquid crystal display device of claim 8, wherein the sensing region has a sensing recess.

10. The liquid crystal display device of claim 2, wherein the image display device comprises:
a thin film transistor including a gate electrode, a semiconductor layer, a source electrode, and a drain electrode;
a pixel electrode connected to the thin film transistor; and
a common electrode receiving a common voltage and generating an electric field together with the pixel electrode.

11. The liquid crystal display device of claim 2, wherein the touch sensor comprises:
a first conductive line;
a second conductive line crossing the first conductive line;
a first conductive pad connected to the first conductive line;
a second conductive pad connected to the second conductive line to be spaced apart from the first conductive pad; and
a connecting electrode formed on a surface of the column spacer to electrically connect the first and second conductive pads by pressing on the second substrate.

12. The liquid crystal display device of claim 11, wherein the first and second conductive pads are formed at substantially the same height.

13. The liquid crystal display device of claim 12, wherein the connecting electrode is spaced apart from each of the first and second conductive pads by about 4,000 to about 5,000 Å.

14. A method of fabricating a liquid crystal display device, the method comprising:
forming a gap maintaining region and a sensing region lower than the gap maintaining region on a first substrate;
forming a first conductive pad connected to a first conductive line and a second conductive pad connected to a second conductive line in the sensing region;
forming a second substrate having at least one column spacer formed at positions corresponding to the gap maintaining and sensing regions;
forming a connecting electrode on a surface of the at least one column spacer; and
injecting liquid crystals between the first and second substrates to bond the first and second substrates.

15. The method of claim 14, wherein forming the gap maintaining region and sensing region comprises:
forming an image display device including a thin film transistor and a pixel electrode on the first substrate;
forming the first and second conductive lines and the first and second conductive pads;
patterning a metal layer or a semiconductor layer on the first substrate to form the gap maintaining region; and
forming the sensing region using an insulating layer.

16. The method of claim 15, wherein forming the gap maintaining region further comprises forming an elastic layer projected upward.

17. The method of claim 16, wherein the elastic layer is formed by patterning an organic layer.

18. The method of claim 15, wherein forming the sensing region further comprises forming a sensing recess by etching the insulating layer.

19. The method of claim 15, wherein the at least one column spacer is formed with substantially the same height.
